(19) United States
(12) Patent Application Publication
(10) Pub. No.: US 2016/0270020 A1
(43) Pub. Date: Sep. 15, 2016

(54) SECURE DEVICE PROVISIONING OF WI-FI DEVICES IN A MULTI-DOMAIN ENVIRONMENT

(71) Applicant: Intel IP Corporation, Santa Clara, CA (US)

(72) Inventors: Farid Adrangi, Lake Oswego, OR (US); Victor Lortz, Beaverton, OR (US); Ganesh Venkatesan, Hillsboro, OR (US); Emily H. Qi, Camas, WA (US)

(21) Appl. No.: 14/976,890

(22) Filed: Dec. 21, 2015

Related U.S. Application Data
(60) Provisional application No. 62/132,893, filed on Mar. 13, 2015.

(51) Int. Cl. H04W 60/00; H04L 29/08

(52) U.S. Cl. CPC H04W 60/00; H04L 67/02

(57) ABSTRACT

This disclosure describes methods, apparatus, and systems related to secure device provisioning system. A first computing device comprising one or more processors and one or more transceiver components may determine data received in a data scan from a second computing device. The first computing device may determine a base Uniform Resource Locator (URL) based on the data. The first computing device may determine a domain-specific suffix based at least in part on a communication domain. The first computing device may append the base URL with a domain-specific suffix. The first computing device may identify domain-specific information from a provisioning server based at least in part on the domain-specific suffix. The first computing device may send a registration request to the provisioning server based at least in part on the domain-specific information. The first computing device may identify a registration notification received from the provisioning server.

### CROSS-REFERENCE TO RELATED APPLICATIONS

This application claims priority to and benefit of U.S. Patent Application Ser. No. 62/132,893 filed on Mar. 13, 2015, and entitled “Secure Device Provisioning of WiFi Devices in Multi Domain Environment.” The disclosure of the aforementioned application is entirely incorporated herein by reference.

### TECHNICAL FIELD

This disclosure generally relates to systems and methods for communications and, more particularly, secure device provisioning of Wi-Fi devices.

### BACKGROUND

Communication devices are becoming widely prevalent and are increasingly requesting access to a variety of communication domains. Wireless domains, for example, may exist in small business, enterprise, homes, etc. A communication device may need to perform secure provisioning before gaining access to a wireless domain.

### BRIEF DESCRIPTION OF THE DRAWINGS

The detailed description is set forth with reference to the accompanying drawings. The use of the same reference numerals indicates similar or identical components or elements; however, different reference numerals may be used as well to indicate components or elements which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIG. 1 depicts a network diagram illustrating an example network environment of an illustrative secure device provisioning system, according to one or more example embodiments of the disclosure;

FIG. 2 depicts an illustrative message flow in a secure device provisioning system, in accordance with one or more example embodiments of the present disclosure;

FIG. 3 depicts an illustrative message flow in a secure device provisioning system, in accordance with one or more example embodiments of the present disclosure;

FIG. 4 depicts an illustrative message flow in a secure device provisioning system, in accordance with one or more example embodiments of the present disclosure;

FIG. 5 depicts an illustrative message flow in a secure device provisioning system, in accordance with one or more example embodiments of the present disclosure;

FIG. 6 depicts a flow diagram of an illustrative process for an illustrative secure device provisioning system, in accordance with one or more embodiments of the disclosure;

FIG. 7 illustrates a functional diagram of an example user device or example access point, according to one or more example embodiments of the disclosure; and

FIG. 8 shows a block diagram of an example of a machine upon which any of one or more techniques (e.g., methods) according to one or more embodiments of the disclosure discussed herein may be performed.

### DETAILED DESCRIPTION

Example embodiments described herein provide certain systems, methods, and devices, for provisioning wireless devices (e.g., Wi-Fi devices) in various wireless networks and domains.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The word “exemplary” is used herein to mean “serving as an example, instance, or illustration.” Any embodiment described herein as “exemplary” is not necessarily to be construed as preferred or advantageous over other embodiments. The terms “computing device”, “user device,” “communication station”, “station” (also referred to as STA), “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, a user equipment (UE), a wireless communication device, or some other similar terminology known in the art. Embodiments disclosed herein generally pertain to wireless networks. Some embodiments can relate to wireless networks that operate in accordance with one of the IEEE 802.11 standards including the IEEE 802.11ax standard.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra-Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

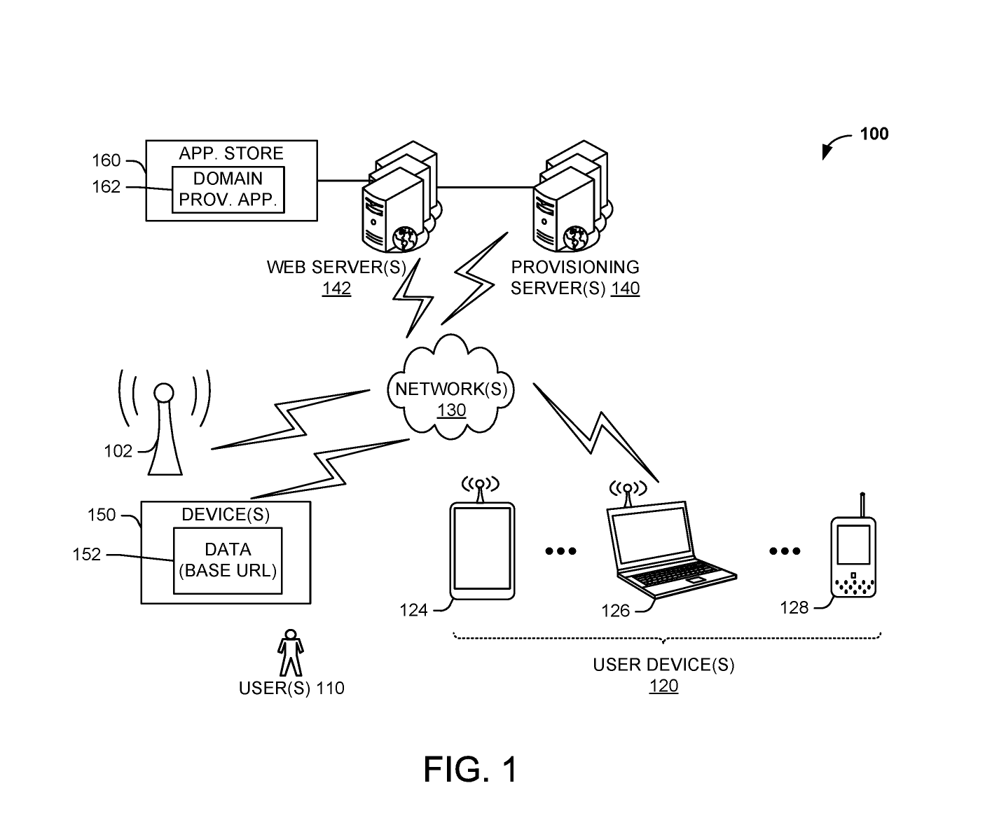

FIG. 1 is a network diagram illustrating an example network environment 100, according to some example embodiments of the present disclosure. Network environment 100 can include one or more user devices 120, one or more devices (e.g., Wi-Fi devices) 150, one or more access point(s) (AP) 102, one or more provisioning server(s) 140 (which may communicate with each other in accordance with one or more communication standards, including the IEEE 802.11 family of standards), and one or more web servers 142. The user device(s) 120 may be mobile devices that are non-stationary and do not have fixed locations. The one or more APs 102 and the provisioning server(s) 140 may be stationary and have fixed locations.

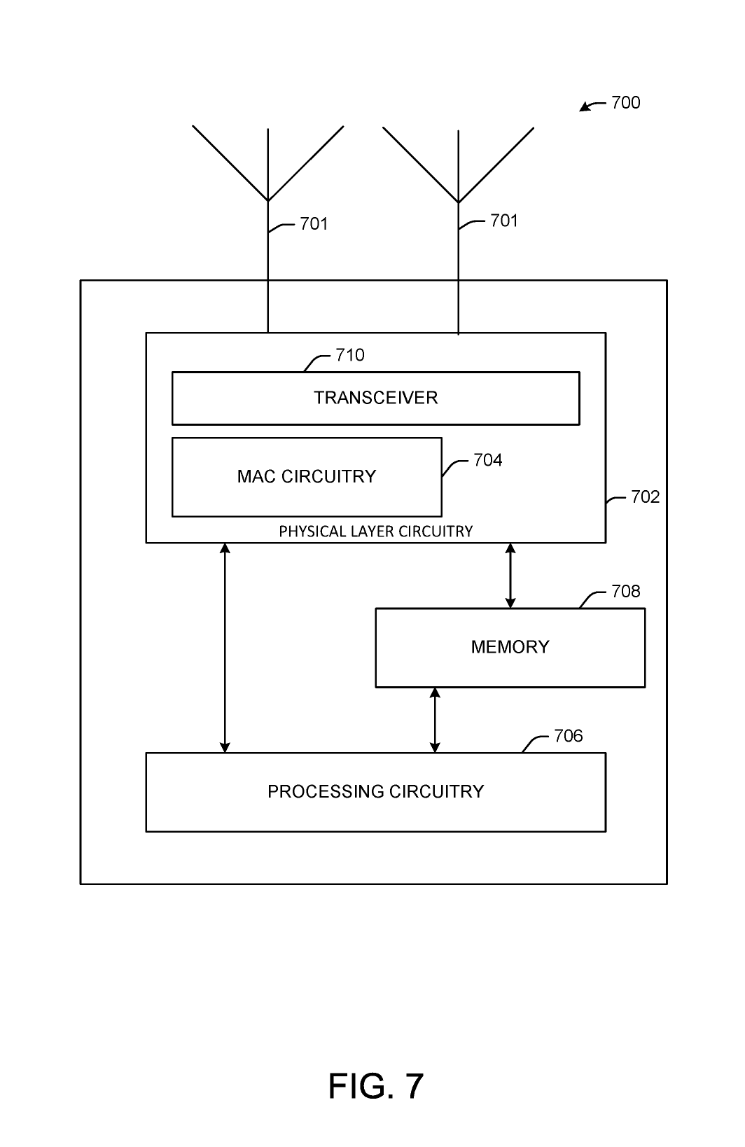

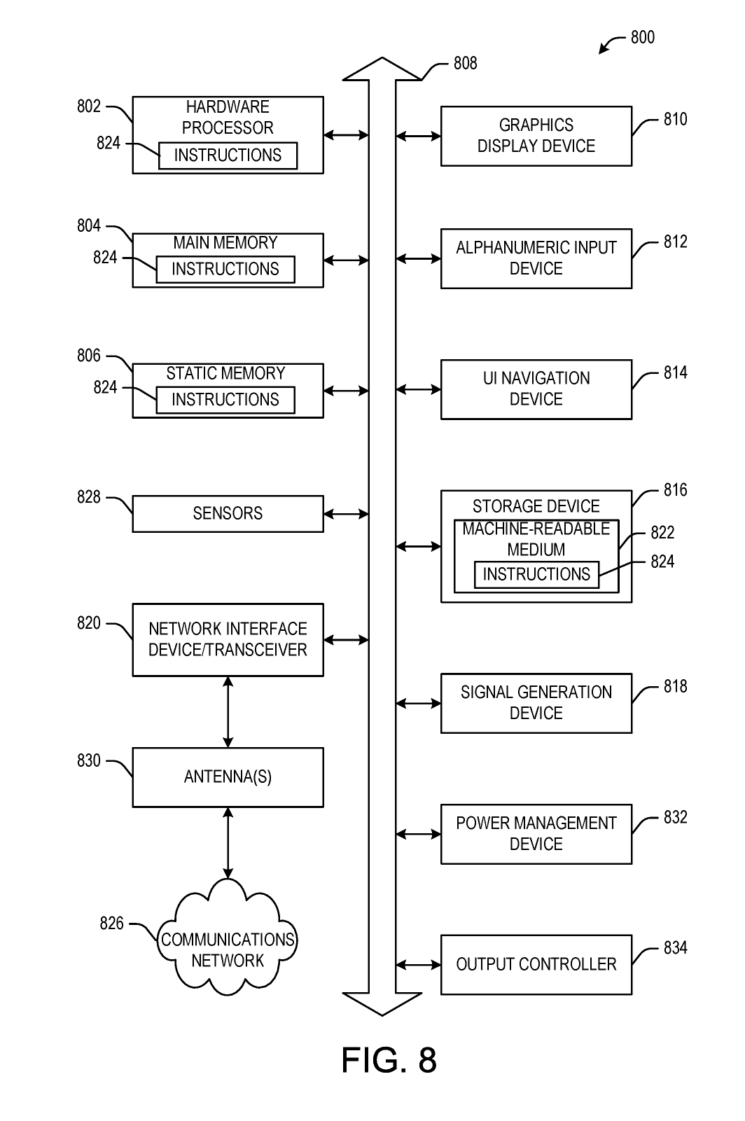

In some embodiments, the user devices 120 and AP 102 can include one or more computer systems similar to that of the functional diagram of FIG. 7 and/or the example machine/system of FIG. 8.

One or more illustrative user devices 120 and one or more devices 150 may be operable by one or more users 110. The user device(s) 120 may include any suitable processor-driven user device including, but not limited to, a desktop computing device, a laptop computing device, a server, a router, a switch, a smartphone, a tablet, wearable wireless device (e.g., bracelet, watch, glasses, ring, etc.) and so forth. The device(s) 150 may include one or more headless IOT devices, televisions and automation systems (including cameras and microphones). In some embodiments, the device(s) 150 may optionally include the AP 102.

Any of the user device(s) 120 (e.g., user devices 124, 126, 128), device(s) 150, provisioning server(s) 140, web server(s) 142 and AP 102 may be configured to communicate with each other via one or more communications networks 130 wirelessly or wired. Any of the communications networks 130 may include, but are not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

The provisioning server(s) 140 may include one or more provisioning services responsible for providing access to one or more user services on the network. Specifically, a provisioning service may allow user devices (e.g., 102) to be provisioned and re-provisioned in real time or near-real time. Further, the provisioning service may monitor access rights and privileges to ensure the security of an enterprise's resources and user privacy. In one or more embodiments of the disclosure, the provisioning server(s) 140 may include one or more access point (AP) provisioning servers, device provisioning servers and service provider provisioning servers.

Any of the user devices 120 (e.g., user devices 124, 126, 128), devices 150, provisioning servers 140, web servers 142, and AP 102 may include one or more communications antennae. Communications antenna may be any suitable type of antenna corresponding to the communications protocols used by the user device(s) 120 (e.g., user devices 124, 124 and 128), device(s) 150 and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user device(s) 120 and device(s) 150.

Any of the user devices 120 (e.g., user devices 124, 126, 128), devices 150, provisioning servers 140, web servers 142 and AP 102 may include any suitable radio and/or transceiver for transmitting and/or receiving radio frequency (RF) signals in the bandwidth and/or channels corresponding to the communications protocols utilized by any of the user devices 120, devices 150, provisioning servers 140, web servers 142 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

One or more embodiments of the disclosure relate to bootstrapping secure provisioning of device(s) 150 into multiple domains. It is understood that bootstrapping usually refers to the starting of a self-sustaining process that is supposed to proceed without external input. Domains may include domains of resource management, authority, and/or ownership. For example, a domain might correspond to a home or a set of devices owned by a private individual. A domain might correspond to a set of devices manufactured by a particular company. A domain might correspond to a media sharing service with copyrighted media assets, such as Sling® TV. A domain might correspond to equipment and data owned by an enterprise, such as Intel®. Furthermore, as trends of bring your own device (BYOD) and Internet of Things gain momentum, it is becoming increasingly common for devices to be associated with different types of domains and also to be simultaneously enrolled in multiple domains. BYOD is a phrase that has become widely adopted to refer to individuals who bring their own computing devices—such as smartphones, laptops, and PDAs—to the workplace for use and connectivity on the secure corporate network. The Internet of Things (IoT) is the network of physical objects or “things” embedded with electronics, software, sensors, and connectivity to enable it to achieve greater value and service by exchanging data with the manufacturer, operator, and/or other connected devices. Each thing is uniquely identifiable through its embedded computing system but is able to interoperate within the existing Internet infrastructure.

One or more embodiments of the disclosure provide an approach to simplifying and improving the user experience and product support challenges for provisioning multi-domain devices. Typical solutions for device setup and registration/enrollment focus only on a configuring a single domain. Each domain defines its own methods to accomplish tasks such as key establishment, account association, and mapping of device-level identities. For example, cellular phones may be provisioned by inserting SIM cards associated with network operators and tied to user accounts. Universal Plug and Play (UPnP) devices may be provisioned by a standardized service such as UPnP Device Protection. Wi-Fi APs and devices are provisioned with protocols such as Extensible Authentication Protocol (EAP) or Wi-Fi Protected Setup.

Since each domain requiring security has already established its own protocols and procedures for device setup, there is minimal chance of displacing these existing methods and establishing a single common method. Consequently, user experience in setting up devices on different domains is inconsistent and sometimes quite poor.

Improvements in user experience typically result in poor security, especially for simple devices with limited processing and I/O capabilities. One or more embodiments of the disclosure provide a significant improvement over previous solutions because it may overcome many of these limitations while remaining compatible with existing protocols and solutions. Further, one or more embodiments provide advantages to device manufacturers by providing a framework allowing them to easily deploy setup applications and companion applications to help manage compatibility issues across multiple generations of devices and protocols.

In one embodiment, the standalone setup capabilities of a device 150 may be supplemented with a cloud-based provisioning service that may work with a user device 120 to enroll the device 150 into a domain. When the device 150 needs to be provisioned, a user device 120 (e.g., a smartphone) connects to a provisioning server 140 using data 152 (e.g., a uniform resource locator (URL)) associated with the device 150. In some cases, the device 150 may expose the URL through a suitable out-of-band channel such as a near field communication (NFC) sticker or a quick response code (QR-code) shown on the device 150 or on its product literature. The user device 120 may use the URL and a provisioning server 140 to obtain compatible setup application(s) (e.g., domain provisioning application 162), additional device capability information, and keys or account information associated with relevant domains. Furthermore, in one embodiment, a single setup URL for a device 150 may be used to bootstrap a device's 150 enrollment in an unlimited number of domains.

Domain enrollment solutions may be classified as managed or unmanaged. Managed solutions for enterprises typically involve preloading software and credentials on client devices and then completing provisioning using management protocols such as LDAP. Mobile networks are also in the managed category, using a combination of web-based interfaces and smartcard (SIM) authentication. E-commerce solutions may be managed or unmanaged, often entirely web-based. Home network devices may also be managed or unmanaged, with the former set up by home automation companies and the latter utilizing a mix of proprietary or standard setup procedures (such as Wi-Fi Protected Setup, Bluetooth “It Just Works”, etc.).

In one embodiment, a general framework for bootstrapping provisioning of multiple domains may be defined using a cloud-based provisioning service and a set of representational state transfer (REST) URL conventions that allow a base URL to be extended to obtain multiple distinct sets of configuration data used by each domain.

In one embodiment, an extensible and scalable framework for bootstrapping enrollment in multiple domains reliably and at low cost may be implemented. For example, device manufacturers may easily help their customers install companion applications and enroll their devices into relevant domains.

In one embodiment, the secure device provisioning system may include one or more devices 150 needing to be enrolled in one or more domains, data 152 containing a base URL associated with the user device's 150 manufacturer, including its model and possibly its unique serial number, a cloud-based provisioning service pointed to by the base URL that may determine current configuration and protocols supported by user device(s) 150. The provisioning service may typically be deployed by or contracted by the device manufacturer on one or more provisioning servers 140. The secure device provisioning system may include one or more mobile devices (e.g., user device(s) 120) that are Internet-connected and capable of reading the base URL and communicating with the provisioning server(s) 140. The secure device provisioning system may include REST-based URL extension convention defining how to combine the base URL with a domain-specific suffix associated with standards groups or other domain owners. The extended URL may allow download of domain-specific setup information such as public keys, device info, etc. Further, the secure device provisioning system may include an application store 160 (which could be enterprise-specific or a standard application store).

In one embodiment, one or more user devices 120 may not contain the provisioning software required to introduce the one or more devices 150 into a domain. In that case, a domain provisioning application 162 may be obtained. For example, in one embodiment, the domain provisioning application 162 may be obtained when a user 110 scans data 152 comprising the base URL using a user device 120 (e.g., a smartphone). The base URL may point to a provisioning service web server 142 such that the base URL may cause a webpage to load in a browser of a user device 120. In some embodiments, the base URL could redirect a user device 120 to an application (i.e., the domain provisioning application 162) in the application store 160.

The webpage loaded into the browser of a user device 120 may provide a device-specific set of options, including installing the manufacturer's companion application or obtaining a domain-specific setup application known to be compatible with a device 150. A user 110 may then click a link to install the appropriate provisioning application for the device 150 and domain. If a suitable domain provisioning application 162 is already installed, this step may be skipped.

The domain provisioning application 162 may then obtain the base URL (obtained from the browser or by re-scanning the URL). The domain provisioning application 162 may extend the base URL with a domain-specific suffix. Using the domain-specific suffix, the domain provisioning application 162 may retrieve domain-specific device information from the provisioning service. The domain provisioning application 162 may use the device information to enroll the device 150 into the domain.

In one embodiment, out-of-band data for the device 150 may be obtained through the provisioning service rather than from a user device 120. There may still be a role for a physical out-of-band channel, but it may be used to help a user device 120 connect to the correct provisioning service for the device 150. From that point forward, the provisioning service may direct the rest of the process through a UI of the user device 120. Delegating key aspects of the setup process to a cloud-based service may provide flexibility to the system both technically and in terms of business relationships. For example, a co-marketing and co-branding arrangement with hardware subsidies and revenue sharing can be supported because the provisioning service may examine the serial number of a device 150 during setup and proceed according to the terms of the co-branding business agreement (helping enroll the device into the co-branded service's domain). This can be done at low cost, because the device SKU itself would not need to be customized for this purpose.

For example, it may be assumed that a device 150 is pre-provisioned with a public/private key pair during manufacture, and the device's 150 public key is stored in a database accessible to its provisioning service. It may further be assumed, for this example, that a user 110 (e.g., a homeowner) purchases a device 150 and wishes to enroll it into the domain of a home automation service provider (SP) and also connect the device 150 to a home Wi-Fi network. It may further be assumed, for this example, that the SP defines a method for enrolling various home automation devices using out-of-band data SP-OOB. Suppose further that the Wi-Fi Alliance defines a method for network setup bootstrapped with out-of-band data WFA-OOB. In one embodiment, the device 150 manufacturer may not need to ship all of its devices 150 with the SP-specific SP-OOB data embedded in them. Instead, the device 150 manufacturer may simply extend the configuration of its provisioning service in the cloud to provide SP-OOB for specific devices 150 from a central and an administered location. Furthermore, the device 150 manufacturer (e.g. ACME.com) might provide links from its base URL to help a user 110 install setup applications for one or more affiliated home automation SPs.

Assuming that a user 110 first installs a setup application for the SP according to the steps described above, further steps would proceed as follows: (1) A user 110 may launch the SP application and may use it to scan a base URL QR-code on a device 150 or its product literature; (2) The SP application may read a base URL from the QR-code. For example, https://ACME.com/dev/ModelX/Serial12345/nonce85467/; (3) The SP application may get the device 150 onto the network to complete its own enrollment. The SP application may append a standard URL extension (e.g., “/WiFi.org/DPP/1.0/”) and may download Wi-Fi-OOB from the ACME.com provisioning service (e.g., https://ACME.com/dev/ModelX/Serial12345/nonce85467/WiF.org/DPP/1.0/). The SP application may use Wi-Fi-OOB to enroll a device 150 into a user's 110 Wi-Fi network using the Wi-Fi Alliance setup protocol. Once the device 150 is successfully added to the network, the SP application can continue and enroll the device 150 into the SP domain. It may append its own proprietary URL extension (e.g., “/ATTHome/setup/1/”) to the base URL and use the result to download SP-OOB (e.g., https://ACME.com/dev/ModelX/Serial12345/nonce85467/ATTHome/setup/1/). This example assumes that ATTHome has established a business relationship with ACME.com so that ACME.com's provisioning service would support the ATTHome URL extension and provide SP-OOB.

Note that if the data required to enroll the device into the SP domain is not available from the provisioning service, the SP application may notify a user 110 and enroll the device 150 using a fallback method. By encouraging the compatibility testing and business relationships between manufacturers and SPs required for integrated domain provisioning according to one or more embodiments, many advantages may be achieved over purely standards-based methods that depend on certification tests and product logos that can be confusing to the customer and inadequate to assure interoperability. Another advantage may be that a customer with a SP setup application in his or her user device 120 may scan a base URL printed on the packaging of a device 150 in a retail store to quickly determine if the device 150 is fully compatible with his or her SP prior to purchase.

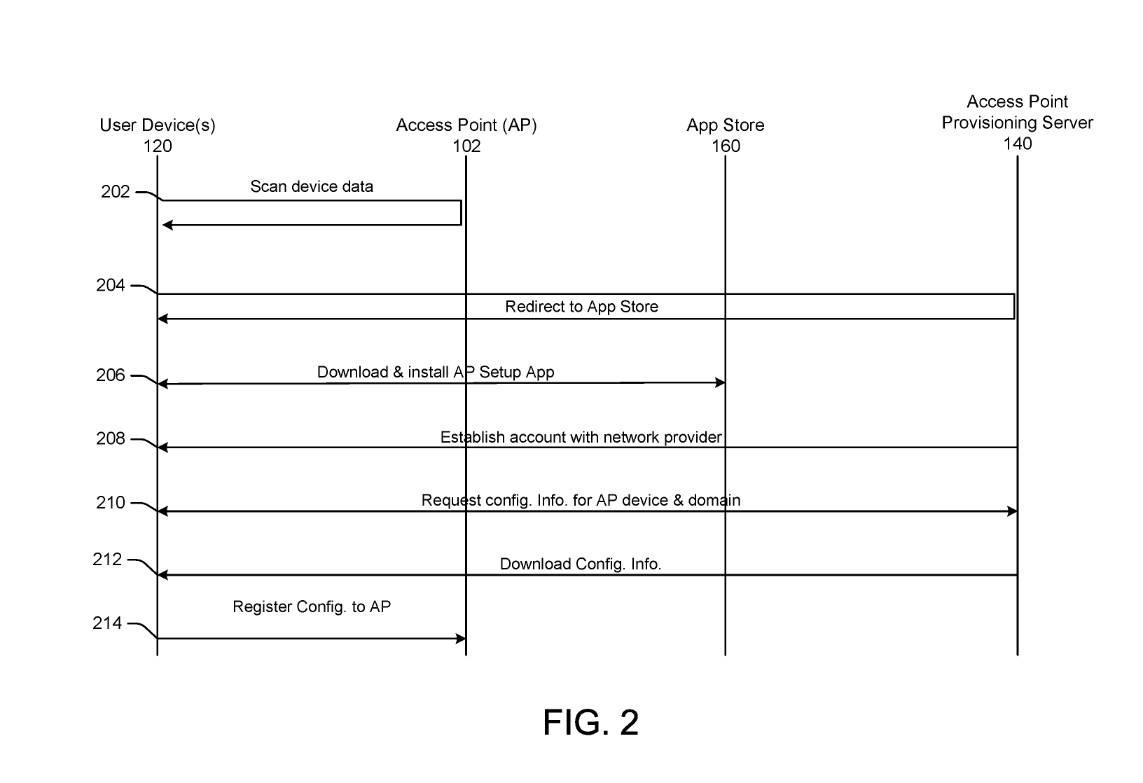

FIG. 2 depicts an illustrative message flow in a secure device provisioning system, in accordance with one or more example embodiments of the present disclosure. In particular, the message flow of FIG. 2 describes the provisioning of the access point (AP) 102 for a specific domain (e.g., small business, enterprise, home, etc.) when one or more of the user devices 120 has its own network connection. For example, one or more user devices 120 may be connected to a network and/or the Internet through communication network 130, such as cellular, Wi-Fi, etc. In one embodiment, in message 202, a user device 120 may contain a scanner application (e.g., a barcode scanner) that performs a scan of data (e.g., a QR code) on the AP 102. A base URL may be retrieved from the data. The base URL may point to a provisioning service's server 140 such that the URL causes a webpage to load in a browser of a user device 120. In some embodiments, in message 204, the URL could immediately redirect a user device 120 to the domain provisioning application 162 in the application store 160.

The webpage may comprise a setup page that may provide a device-specific set of options, including installing the AP 102's manufacturer's companion application or obtaining a domain provisioning application 162 known to be compatible with the AP 102. In message 206, a user 110 may click a link on the setup page to install the appropriate domain provisioning application 162 for the AP 102 and domain. If a suitable domain provisioning application 162 is already installed, this step may be skipped.

In one or more embodiments, in message 208, the domain provisioning application 162 (i.e., the AP setup application shown in FIG. 2) executing on a user device 120 may optionally be utilized to establish an account with a network provider. In messages 210, 212, and 214, the domain provisioning application 162 may further be utilized to send a request for configuration information for the AP 102 and a specific domain, download WiFi-OOB configuration information for the AP 102 (including public key/certificate configuration information, etc.) and register the configuration to the AP 102 (e.g., provision keys and establish ownership and configuration rights).

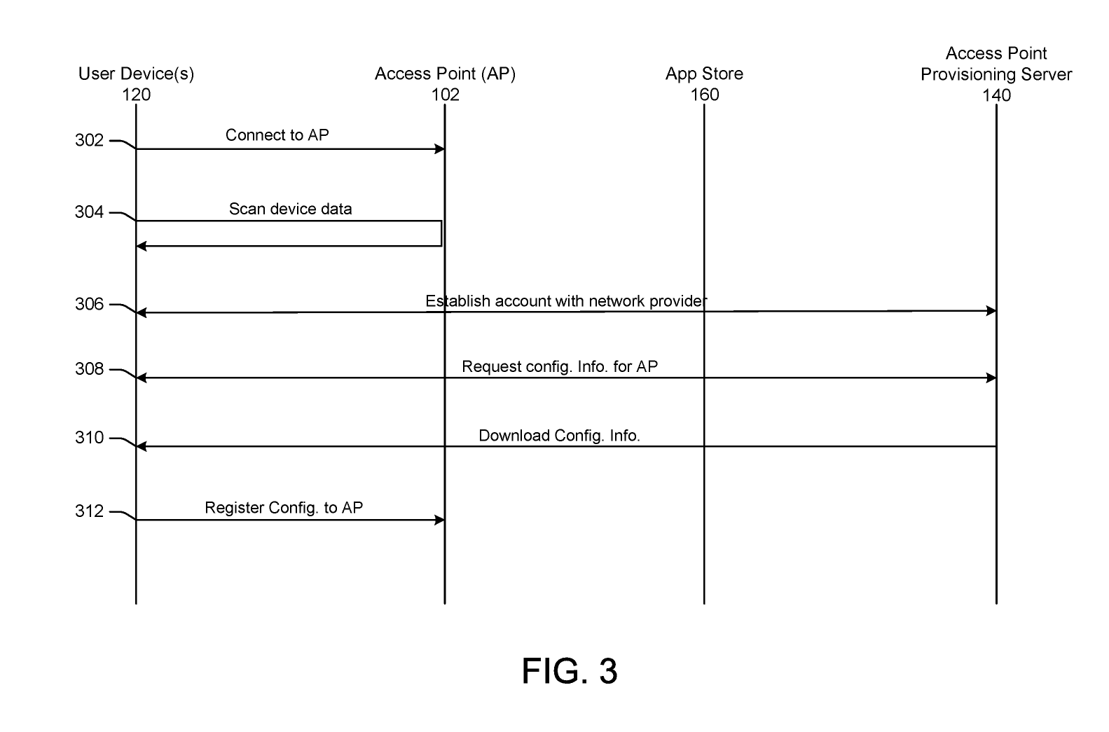

FIG. 3 depicts an illustrative message flow in a secure device provisioning system, in accordance with one or more example embodiments of the present disclosure. In particular, the message flow of FIG. 3 describes the provisioning of the access point (AP) 102 for a specific domain (e.g., small business, enterprise, home, etc.) when one or more of the user devices 120 does not have an established network (e.g., Internet) connection. In this example, a user device 120 may have a pre-installed AP Setup Application with out-of-box AP SSID and WPA Keys. It should be understood that in some embodiments, the AP Setup Application may comprise the domain provisioning application 162.

As described in the message flow, in message 302, a user device 120 may connect to the AP 102 utilizing the aforementioned out-of-box SSID and WPA keys from the AP Setup Application. In message 304, the AP Setup Application may then be utilized to scan the data 152 (e.g., a QR code) from the AP 102. In message 306, the AP Setup Application may then optionally be utilized to communicate with an AP provisioning server 140 to establish an account with a network provider. In messages 308, 310, and 312, the AP Setup Application may then be utilized to request configuration information (WiFi-OOB) for the AP 102, download configuration information (including AP public key/certificate configuration information, etc.), and register the configuration to the AP 102 (e.g., provision keys and establish ownership and configuration rights), respectively.

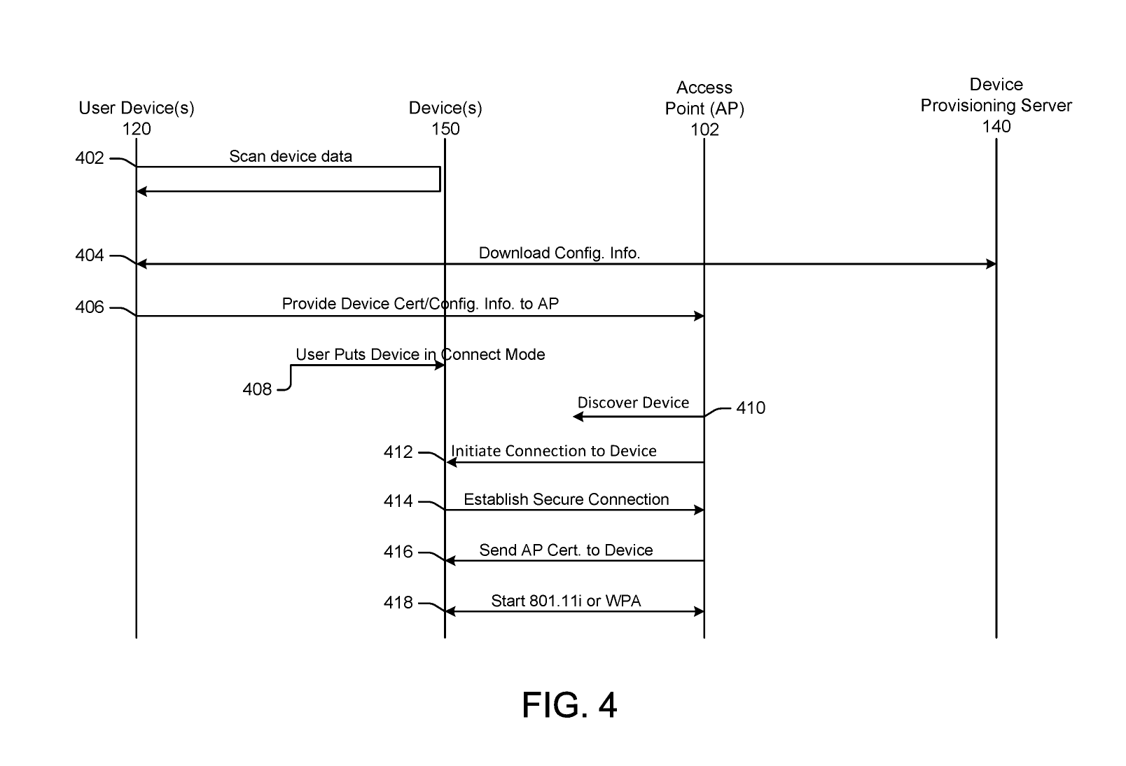

FIG. 4 depicts an illustrative message flow in a secure device provisioning system, in accordance with one or more example embodiments of the present disclosure. In this example message flow, a user device 120 may wish to securely and conveniently connect other Wi-Fi devices (i.e., one or more devices 150) to the AP 102. Some examples of these devices may include, but are not limited to, headless IOT devices, televisions and home automation devices (including cameras, microphones, etc.). It is understood that that each of these headless IOT devices may come with its own specific Wi-Fi capabilities and embedded security parameters. Because of user interface (UI) limitations, users 110 may not have an option to interact with these headless devices to configure them manually. Although this example describes other Wi-Fi devices, other wireless devices may also be configured to connect to the AP 102.

In one embodiment, in message 402, a user device 120 may contain a scanner application (e.g., a barcode scanner) that performs a scan of data 152 (e.g., a QR code) on a device 150. A base URL may be retrieved from the scanned data 152. The base URL may point to a device provisioning server 140 such that the URL causes a webpage to load in a browser of a user device 120. In some embodiments, the URL could immediately redirect a user device 120 to the domain provisioning application 162 in the application store 160.

The webpage may comprise a setup page that may provide a device-specific set of options, including installing a device 150's manufacturer's companion application or obtaining a domain provisioning application 162 known to be compatible with a device 150. A user 110 may click a link on the setup page to install the appropriate domain provisioning application 162 for a device 150 and a domain. If a suitable domain provisioning application 162 is already installed, this step may be skipped.

In one or more embodiments, in messages 404 and 406, the domain provisioning application 162 (i.e., the AP setup application shown in FIG. 4) executing on a user device 120 may be utilized to download WiFi-OOB configuration information for a device 150 (including public key/certificate configuration information, etc.) and provide a device's certificate/configuration information to the AP 102. In message 408, a user 110 may then optionally place a device 150 in a connect mode. In messages 410 and 412, the AP 102 may then discover the device 150 and initiate a connection to the device 150. In message 414, the device 150 may then establish a secure connection to the AP 102 using public keys and derive a pairwise master key (PMK). In messages 416 and 418, the AP 102 may then send an AP certificate to the device 150 and an 801.11i or WPA connection between the AP 102 and the device 150 may then be established.

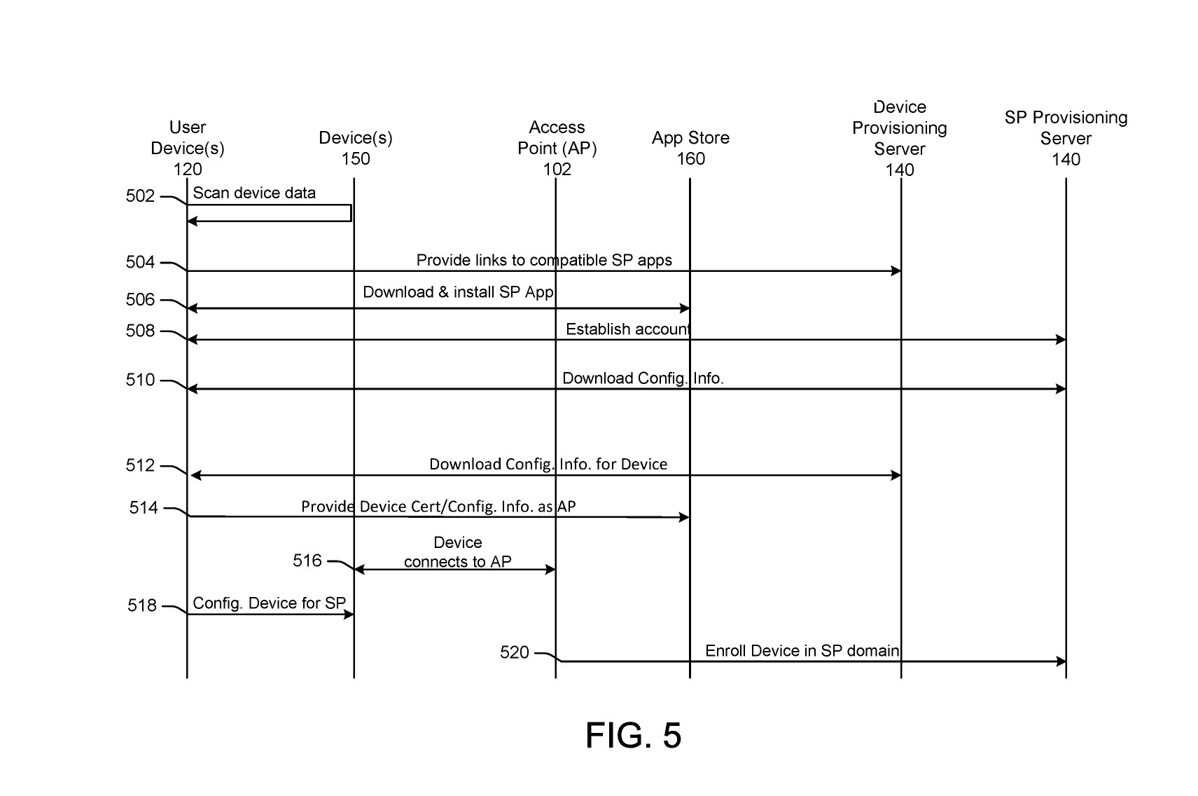

FIG. 5 depicts an illustrative message flow in a secure device provisioning system, in accordance with one or more example embodiments of the present disclosure. In this example message flow, a user device 120 may wish to securely and conveniently add other Wi-Fi devices (i.e., one or more devices 150) to a Service Provider Domain using the service provider provisioning server 140. Some examples of these devices may include, but are not limited to, headless IOT devices, televisions and home automation devices (including cameras, microphones, etc.). It is understood that that each of these headless IOT devices may come with its own specific Wi-Fi capabilities and embedded security parameters. Because of user interface (UI) limitations, users 110 may not have an option to interact with these headless devices to configure them manually. Although this example describes other Wi-Fi devices, other wireless devices may also be configured to connect to the AP 102.

In one embodiment, in message 502, a user device 120 may contain a scanner application (e.g., a barcode scanner) that performs a scan of data 152 (e.g., a QR code) on a device 150. A base URL may be retrieved from the scanned data 152. The base URL may point to a device provisioning server 140 such that the URL causes a webpage to load in a browser of a user device 120. In some embodiments, the URL could immediately redirect a user device 120 to the domain provisioning application 162 in the application store 160.

In message 504, the webpage may comprise a setup page that may provide a device-specific set of options, including installing a device 150′s manufacturer's companion application or obtaining a domain provisioning application 162 known to be compatible with a device 150 from the application store 160. In message 506, a user 110 may click a link on the setup page to download and install the appropriate domain provisioning application 162 for a device 150 and a domain from the application store 160. If a suitable domain provisioning application 162 is already installed, this step may be skipped.

In one or more embodiments, in messages 508, 512, 512, and 514, the domain provisioning application 162 (i.e., the Service Provider Application shown in FIG. 5) executing on a user device 120 may be utilized to establish an account with a service provider, download service provider out-of-band (SP-OOB) configuration information for a device 150 (including public key/certificate configuration information, etc.), download WiFi-OOB configuration information for the device 150 (including public key/certificate configuration information, etc.), and provide a device 150's certificate/configuration information (i.e., serving as the AP 102) to the application store 160, respectively. In message 516, a user 110 may then connect the device 150 to the AP 102. In message 518, the user device 120 may then configure the device 150 for the service provider using previously downloaded SP-OOB configuration information. In message 520, the AP 102 may enroll the user device 102 in the service provider's domain.

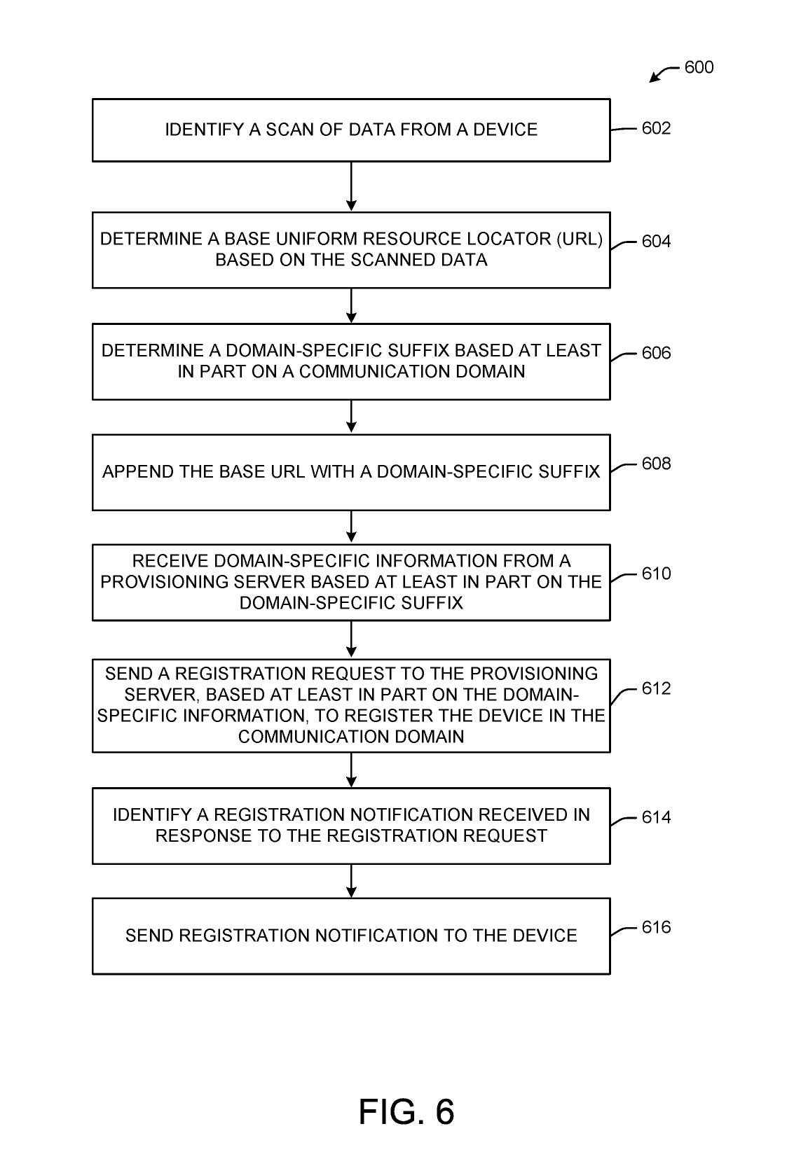

FIG. 6 illustrates a flow diagram of illustrative process 600 for a secure device provisioning system in accordance with one or more embodiments of the disclosure. The method 600 may be performed by a user device 120 and the processor(s) 802 thereon in cooperation with one or more other entities of the network environment 100.

At block 602, the user device 120 may identify a scan of data 152 (e.g., a QR Code) from a device 150 to be enrolled in a domain. At block 604, the user device 120 may determine a base Uniform Resource Locator (URL) based on the scanned data. In some embodiments, the user device 120 may also utilize the scanned data in determining compatibility with a service provider. In some embodiments, the base URL may point to a web server 152 associated with a provisioning server 140. In other embodiments, the base URL may point to the application store 160. For example, the base URL may redirect the user device 120 to the application store 160 for installing the domain provisioning application 162 which is associated with the provisioning server 140. In some embodiments, the domain provisioning application 162 may be utilized to obtain out-of-band data from the provisioning server 140.

At block 606, the user device 120 may determine a domain-specific suffix (to combine with the base URL) based at least in part on a communication domain. In some embodiments, the communication domain may include one or more of a private domain, a manufacturer domain, a media sharing domain, and an enterprise domain.

At block 608, the user device 120 may append the base URL with a domain-specific suffix. At block 610, the user device 120 may receive domain-specific information from a provisioning server 140 based at least in part on the domain-specific suffix. At block 612, the user device 120 may send a registration request to the provisioning server 140 based at least in part on the domain-specific information. At block 614, the user device 120 may identify a registration notification received in response to the registration request. At block 616, the user device 120 may send the registration notification to the device 150 to notify the device 150 of its enrollment in the service provider's domain.

It should be noted, that the method 600 may be modified in various ways in accordance with certain embodiments of the disclosure. For example, one or more operations of method 600 may be eliminated or executed out of order in other embodiments of the disclosure. Additionally, other operations may be added to method 600 in accordance with other embodiments of the disclosure.

FIG. 7 shows a functional diagram of an exemplary communication station 700 in accordance with some embodiments. In one embodiment, FIG. 7 illustrates a functional block diagram of a communication station that may be suitable for use as an AP 102 (FIG. 1), a user device 120 (FIG. 1) or a device 150 in accordance with some embodiments. In particular, the communication station 700 may be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 700 may include physical layer circuitry 702 having a transceiver 710 for transmitting and receiving signals to and from other communication stations using one or more antennas 701. The physical layer circuitry 702 may also include medium access control (MAC) circuitry 704 for controlling access to the wireless medium. The communication station 700 may also include processing circuitry 706 and memory 708 arranged to perform the operations described herein. In some embodiments, the physical layer circuitry 702 and the processing circuitry 706 may be configured to perform operations detailed in FIGS. 2-6.

In accordance with some embodiments, the MAC circuitry 704 may be arranged to contend for a wireless medium and configure frames or packets for communicating over the wireless medium and the physical layer circuitry 702 may be arranged to transmit and receive signals. The physical layer circuitry 702 may include circuitry for modulation/demodulation, upconversion/downconversion, filtering, amplification, etc. In some embodiments, the processing circuitry 706 of the communication station 700 may include one or more processors. In other embodiments, two or more antennas 701 may be coupled to the physical layer circuitry 702 arranged for sending and receiving signals. The memory 708 may store information for configuring the processing circuitry 706 to perform operations for configuring and transmitting message frames and performing the various operations described herein. The memory 708 may include any type of memory, including non-transitory memory, for storing information in a form readable by a machine (e.g., a computer). For example, the memory 708 may include a computer-readable storage device may, read-only memory (ROM), random-access memory (RAM), magnetic disk storage media, optical storage media, flash-memory devices and other storage devices and media.

In some embodiments, the communication station 700 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 700 may include one or more antennas 701. The antennas 701 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 700 may include one or more of a keyboard, a display, a non-volatile memory port, multiple antennas, a graphics processor, an application processor, speakers, and other mobile device elements. The display may be an LCD screen including a touch screen.

Although the communication station 700 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 700 may refer to one or more processes operating on one or more processing elements.

Certain embodiments may be implemented in one or a combination of hardware, firmware and software. Other embodiments may also be implemented as instructions stored on a computer-readable storage device, which may be read and executed by at least one processor to perform the operations described herein. The instructions may be in any suitable form, such as but not limited to source code, compiled code, interpreted code, executable code, static code, dynamic code, and the like. A computer-readable storage device or medium may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 700 may include one or more processors and may be configured with instructions stored on a computer-readable storage device memory.

FIG. 8 illustrates a block diagram of an example of a machine 800 or system upon which any one or more of the techniques (e.g., methodologies) discussed herein may be performed. In other embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a power management device 832, a graphics display device 810, an alphanumeric input device 812 (e.g., a keyboard), and a user interface (UI) navigation device 814 (e.g., a mouse). In an example, the graphics display device 810, alphanumeric input device 812 and UI navigation device 814 may be a touch screen display. The machine 800 may additionally include a storage device (i.e., drive unit) 816, a signal generation device 818 (e.g., a speaker), a network interface device/transceiver 820 coupled to antenna(s) 830, and one or more sensors 828, such as a global positioning system (GPS) sensor, compass, accelerometer, or other sensor. The machine 800 may include an output controller 834, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within the static memory 806, or within the hardware processor 802 during execution thereof by the machine 800. In an example, one or any combination of the hardware processor 802, the main memory 804, the static memory 806, or the storage device 816 may constitute machine-readable media.

While the machine-readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples may include solid-state memories, and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device/transceiver 820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 820 may include one or more physical jacks (e.g., Ethernet, coaxial, or phone jacks) or one or more antennas to connect to the communications network 826. In an example, the network interface device/transceiver 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800, and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

According to example embodiments of the disclosure, there may be a device. The device may include at least one memory that stores computer-executable instructions and at least one processor. The at least one memory and the at least one processor may be configured to access the at least one memory and further be configured to execute the computer-executable instructions to: determine data received in a data scan from a data source; determine a base Uniform Resource Locator (URL) based on the data; determine a domain-specific suffix based at least in part on a communication domain; append the base URL with a domain-specific suffix; identify domain-specific information received from a provisioning server based at least in part on the domain-specific suffix; a registration request to the provisioning server, based at least in part on the domain-specific information, to register the data source in the communication domain; and identify a registration notification received from the provisioning server. In example embodiments, the device may include a radio or transceiver having one or more antennas. In further example embodiments wherein the at least one processor may be further configured to send the registration notification to the data source. In still further example embodiments, the communication domain may include at least one of a private domain, a manufacturer domain, a media sharing domain, and an enterprise domain. In some further example embodiments, the base URL may point to a web server associated with the provisioning server. In some further example embodiments, the at least one processor may be further configured to obtain out-of-band data from the provisioning server. In some further example embodiments, the at least one processor may be further configured to determine compatibility with a service provider based at least in part on the data. In some further example embodiments, the base URL may redirect the device to an application store. In some further example embodiments, the at least one processor may be further configured to install a provisioning application associated with the provisioning server.

According to example embodiments of the disclosure, there may be a method. The method may include determining, by a first computing device comprising one or more processors and one or more transceiver components, data received in a data scan from a second computing device; determining, by the first computing device, a base Uniform Resource Locator (URL) based on the data; determining, by the first computing device, a domain-specific suffix based at least in part on a communication domain; appending, by the first computing device, the base URL with a domain-specific suffix; identifying, by the first computing device, domain-specific information received from a provisioning server based at least in part on the domain-specific suffix; sending, by the first computing device, a registration request to the provisioning server based at least in part on the domain-specific information, to register the second computing device in the communication domain; and identifying, by the first computing device, a registration notification received from the provisioning server. In example embodiments, the method may further include sending the registration notification to the second computing device. In further example embodiments, the communication domain may include at least one of a private domain, a manufacturer domain, a media sharing domain, and an enterprise domain. In still further example embodiments, the base URL may point to a web server associated with the provisioning server. In some further example embodiments, the method may further include obtaining from the provisioning server out-of-band data associated with the first computing device. In some further example embodiments, the method may further include determining compatibility with a service provider based at least in part on the data. In some further example embodiments, the base URL may redirect the first computing device to an application store. In some further example embodiments, the method may further include installing a provisioning application associated with the provisioning server.

According to example embodiments of the disclosure, there may be a computer-readable non-transitory storage medium. The medium may contain instructions, which when executed by one or more processors result in performing operations including: determining data received in a data scan from a device; determining a base Uniform Resource Locator (URL) based on the data; determining a domain-specific suffix based at least in part on a communication domain; appending the base URL with a domain-specific suffix; identifying domain-specific information from a provisioning server based at least in part on the domain-specific suffix; causing to send a registration request to the provisioning server, based at least in part on the domain-specific information, to register the device in the communication domain; and identifying a registration notification received from the provisioning server. In example embodiments, the operations may further include sending the registration notification to the device. In still further example embodiments, the communication domain may include at least one of a private domain, a manufacturer domain, a media sharing domain, and an enterprise domain. In some further example embodiments, the base URL may point to a web server associated with the provisioning server. In some further example embodiments, the operations may further include determining compatibility with a service provider based at least in part on the data. In some further example embodiments, the base URL may point to an application store.

According to example embodiments of the disclosure, there may be an apparatus. The apparatus may include a means for identifying, by a first computing device comprising one or more processors and one or more transceiver components, data received in a data scan from a second computing device; determining, by the first computing device, a base Uniform Resource Locator (URL) based on the data; determining, by the first computing device, a domain-specific suffix based at least in part on a communication domain; appending, by the first computing device, the base URL with a domain-specific suffix; identifying, by the first computing device, domain-specific information from a provisioning server based at least in part on the domain-specific suffix; sending, by the first computing device, a registration request to the provisioning server based at least in part on the domain-specific information, to register the second computing device in the communication domain; and identifying, by the first computing device, a registration notification received from the provisioning server. In example embodiments, the apparatus may further include a means for sending the registration notification to the second computing device. In further example embodiments, the communication domain may include at least one of a private domain, a manufacturer domain, a media sharing domain, and an enterprise domain. In still further example embodiments, the base URL may point to a web server associated with the provisioning server. In some further example embodiments, the apparatus may further include a means for obtaining from the provisioning server out-of-band data associated with the first computing device. In some further example embodiments, there may be a means for determining compatibility with a service provider based at least in part on the data. In some further example embodiments, the base URL may redirect the first computing device to an application store. In some further example embodiments, the apparatus may further include a means for installing a provisioning application associated with the provisioning server.

What is claimed is:

1. A computer-readable non-transitory storage medium that contains instructions, which when executed by one or more processors result in performing operations comprising:
determining data received in a data scan from a device;
determining a base Uniform Resource Locator (URL) based at least in part on the data;
determining a domain-specific suffix based at least in part on a communication domain;
appending the base URL with the domain-specific suffix;
identifying domain-specific information received from a provisioning server based at least in part on the domain-specific suffix;
causing to send a registration request to the provisioning server, based at least in part on the domain-specific information, to register the device in the communication domain; and
identifying a registration notification received from the provisioning server.

2. The medium of claim 1, wherein the operations further comprise causing to send the registration notification to the device.

3. The medium of claim 1, wherein the communication domain includes at least one of a private domain, a manufacturer domain, a media sharing domain, and an enterprise domain.

4. The medium of claim 1, wherein the base URL points to a web server associated with the provisioning server.

5. The medium of claim 1, wherein the operations further comprise determining compatibility with a service provider based at least in part on the data.

6. The medium of claim 1, wherein the base URL points to an application store.

7. A device, comprising:
at least one memory that stores computer-executable instructions; and
at least one processor configured to access the at least one memory and configured to execute the computer-executable instructions to:
determine data received in a data scan from a data source;
determine a base Uniform Resource Locator (URL) based on the data;
determine a domain-specific suffix based at least in part on a communication domain;
append the base URL with a domain-specific suffix;
identify domain-specific information received from a provisioning server based at least in part on the domain-specific suffix;
send a registration request to the provisioning server, based at least in part on the domain-specific information, to register the data source in the communication domain; and
identify a registration notification received from the provisioning server.

8. The device of claim 7, wherein the at least one processor is further configured to execute the computer-executable instructions to send the registration notification to the data source.

9. The device of claim 7, wherein the communication domain includes at least one of a private domain, a manufacturer domain, a media sharing domain, and an enterprise domain.

10. The device of claim 7, wherein the base URL points to a web server associated with the provisioning server.

11. The device of claim 7, wherein the at least one processor is further configured to execute the computer-executable instructions to obtain out-of-band data from the provisioning server.

12. The device of claim 7, wherein the at least one processor is further configured to execute the computer-executable instructions to determine compatibility with a service provider based at least in part on the data.

13. The device of claim 7, wherein the base URL redirects the device to an application store.

14. The device of claim 7, wherein the at least one processor is further configured to execute the computer-executable instructions to install a provisioning application associated with the provisioning server.

15. The device of claim 7, further comprising a transceiver.

16. The device of claim 7, further comprising one or more antennas.

17. A method comprising:
determining, by a first computing device comprising one or more processors and one or more transceiver components, data received in a data scan from a second computing device;
determining, by the first computing device, a base Uniform Resource Locator (URL) based on the data;
determining, by the first computing device, a domain-specific suffix based at least in part on a communication domain;
appending, by the first computing device, the base URL with a domain-specific suffix;
identifying, by the first computing device, domain-specific information received from a provisioning server based at least in part on the domain-specific suffix;
sending, by the first computing device, a registration request to the provisioning server based at least in part on the domain-specific information, to register the second computing device in the communication domain; and
identifying, by the first computing device, a registration notification received rom the provisioning server.

18. The method of claim 17, further comprising sending the registration notification to the second computing device.

19. The method of claim 17, wherein the communication domain includes at least one of a private domain, a manufacturer domain, a media sharing domain, and an enterprise domain.

20. The method of claim 17, wherein the base URL points to a web server associated with the provisioning server.

21. The method of claim 17, further comprising obtaining from the provisioning server out-of-band data associated with the first computing device.

22. The method of claim 17, further comprising determining compatibility with a service provider based at least in part on the data.

23. The method of claim 17, wherein the base URL redirects the first computing device to an application store.

24. The method of claim 17, further comprising installing a provisioning application associated with the provisioning server.
